(19) United States
(12) Patent Application Publication
(10) Pub. No.: US 2025/0231798 A1
(43) Pub. Date: Jul. 17, 2025

(54) DAG JOB SCHEDULING METHOD AND SYSTEM

(71) Applicants: HAINAN INSTITUTE OF ZHEJIANG UNIVERSITY, Sanya City (CN); ZHEJIANG UNIVERSITY, Hangzhou City (CN)

(72) Inventors: Hailiang ZHAO, Hangzhou City (CN); Shuiguang DENG, Hangzhou City (CN); Guanjie CHENG, Hangzhou City (CN); Jianwei YIN, Hangzhou City (CN)

(21) Appl. No.: 19/016,731

(22) Filed: Jan. 10, 2025

Related U.S. Application Data
(63) Continuation of application No. PCT/CN2024/073551, filed on Jan. 23, 2024.

(30) Foreign Application Priority Data
Jan. 15, 2024 (CN) 202410054049.9

(51) Int. Cl. G06F 9/48

(52) U.S. Cl. CPC G06F 9/4881

(57) ABSTRACT

A DAG job scheduling method includes following steps when a progress state of a job is updated: acquiring native feature data of each of jobs; performing embedding feature vector extraction on the native feature data based on a graph convolution neural network, and generating state feature vectors based on an extraction result; inputting the state feature vectors into a first prediction network, and predicting scheduling probability of respective candidate tasks by the first prediction network to obtain scheduling priorities of the respective candidate tasks; and selecting allocation nodes for the candidate tasks sequentially in an order of the scheduling priorities from large to small based on the state feature vectors and generating a scheduling strategy based on a selection result. The scheduling strategy provided in the disclosure can improve efficiency globally and can also reduce caching overhead of intermediate data in a job execution process.

### TECHNICAL FIELD

The disclosure relates to the field of cloud computing, in particular to DAG job scheduling technology based on Kubernetes in a cloud native environment.

### BACKGROUND ART

In recent years, cloud native has gradually become a standard paradigm in the era of cloud computing 2.0. The cloud native uses an open-source stack to containerize workload, improves flexibility and maintainability based on a micro-service architecture, supports continuous iteration and operation and maintenance automation by means of agile methods and DevOps, and uses cloud platform facilities to realize flexible scaling, dynamic scheduling and optimization of resource utilization.

Kubernetes, which is an open source container cluster management system, provides application deployment, maintenance, extension mechanism and other functions. Submitting a job on Kubernetes requires uploading a yaml file (a type of configuration file) that clearly defines execution content and resource requirements of respective assemblies in a specified format, and then Kubernetes will start to schedule and execute the respective assemblies in the job according to scheduling strategies and rules.

However, currently, Kubernetes' scheduling ability for computing tasks with a structure of “Directed Acyclic Graph (DAG for short)” needs to be improved.

### SUMMARY

In view of shortcoming of poor scheduling ability of Kubernetes to DAG jobs in related art, the disclosure provides DAG job scheduling technology based on policy search and a graph convolution network.

In order to solve the above technical problems, the present disclosure provides following technical solutions.

A DAG job scheduling method includes following steps when a progress state of a job is updated:
acquiring native feature data of each of jobs;
   the native feature data including a job native feature vector and task native feature vectors in one-to-one correspondence to tasks;
   the job native feature vector including node allocation information of the job; and
   each of the task native feature vectors including the node allocation information and further including resource occupation information of a corresponding task;
performing embedding feature vector extraction on the native feature data based on a graph convolution neural network, and generating state feature vectors based on an extraction result;
   recording tasks of the jobs as candidate tasks, the state feature vectors being in one-to-one correspondence to the candidate tasks;
inputting the state feature vectors into a first prediction network, and predicting scheduling probability of respective candidate tasks by the first prediction network to obtain scheduling priorities of the respective candidate tasks; and
selecting allocation nodes for the candidate tasks sequentially in an order of the scheduling priorities from large to small based on the state feature vectors and generating a scheduling strategy based on a selection result.

As a possible implementation:
the extraction result includes:
task embedding feature vectors in one-to-one correspondence to the candidate tasks;
job embedding feature vectors in one-to-one correspondence to the jobs; and
a global embedding feature vector.

The state feature vectors includes the global feature vector, and further includes task feature vectors corresponding to the candidate tasks and a job feature vector.

As a possible implementation:
the graph convolution neural network includes:
a first extraction network configured to generate a task embedding feature vector of a candidate task based on a job native feature vector and a task native feature vector of the candidate task and a task embedding feature vector of a child task of the candidate task;
a second extraction network configured to generate a job embedding feature vector of a job based on a job native feature vector of the job and task embedding feature vectors corresponding to the job; and
a third extraction network configured to generate the global embedding feature vector based on respective job embedding feature vectors.

As a possible implementation, the selecting allocation nodes for the candidate tasks specifically includes:
taking a candidate task currently to be allocated with a node as a target task;
screening out a nodes meeting execution of the target task to obtain a candidate node;
acquiring node feature vectors of respective candidate nodes, each of the node feature vectors including resource utilization data of a corresponding node; and
calculating allocating priorities of the respective candidate nodes based on the node feature vectors and a state feature vector of the target task and taking a candidate node with a highest allocating priority as a target node of the target task.

As a possible implementation:
allocating probabilities of the respective candidate nodes are predicted by a second prediction network based on the node feature vectors and the state feature vector of the target task so as to obtain the allocating priorities of the respective candidate nodes.

As a possible implementation, the scheduling strategy includes at least one scheduling action, and the at least one scheduling action is used to indicate a task and a nodes for performing of scheduling;
after the scheduling strategy is generated, rewards corresponding to respective scheduling actions are calculated based on a preset optimization goal, and an accumulated reward is obtained by statistics; and

The preset optimization goal is to advance completion time of a last job and reduce caching overhead occupied by intermediate data in a cluster.

The accumulated reward is used to update the graph convolution neural network and the first prediction network.

As a possible implementation, a formula for calculating a reward rₖ₋₁ of a k−1-th scheduling action is:

$${r}_{k - 1} = - ( {t}_{k} - {t}_{k - 1} ) ( \vert {J}_{k} \vert + \vert ξ ( {J}_{k} ) \vert ) ;$$

in which
tₖ represents global time when a k-th scheduling action is triggered;
tₖ₋₁ represents global time when a k−1-th scheduling action is triggered;
Jₖ is a set of unfinished tasks in a time period [tₖ₋₁, tₖ);
ξ(Jₖ) is a set of parent tasks of all of tasks in Jₖ;
   |Jₖ| is a number of elements in Jₖ; and
   |ξ(Jₖ)| is a number of elements in ξ(Jₖ).

A DAG job scheduling system includes:
a monitoring module configured to acquire and transmit native feature data of each of jobs when a progress state of the job is updated;
   the native feature data including a job native feature vector and task native feature vectors in one-to-one correspondence to tasks;
   the job native feature vector including node allocation information of the job; and
   each of the task native feature vectors including the node allocation information and further including resource occupation information of a corresponding task; and
a proxy pattern configured to generate a corresponding scheduling strategy based on the native feature data.

The proxy pattern includes:
a feature extraction unit configured to perform embedding feature vector extraction on the native feature data based on a graph convolution neural network, and generate state feature vectors based on an extraction result; and record tasks of the jobs as candidate tasks, the state feature vectors being in one-to-one correspondence to the candidate tasks;
a first strategy unit configured to the state feature vectors into a first prediction network, and predicting scheduling probability of respective candidate tasks by the first prediction network to obtain scheduling priorities of the respective candidate tasks; and
a second strategy unit configured to select allocation nodes for the candidate tasks sequentially in an order of the scheduling priorities from large to small and generate a scheduling strategy based on a selection result.

As a possible implementation, the DAG job scheduling system further includes a Kubernetes platform.

The Kubernetes platform is configured to generate a corresponding RPC request when the progress state of the job is updated, and the RPC request includes the native feature data of each of the jobs.

The monitoring module is configured to receive the RPC request and obtain the native feature data.

The second strategy unit is further configured to generate a corresponding RPC response based on the scheduling strategy and feedback the RPC response to the Kubernetes platform.

The disclosure further provides a computer-readable storage medium having a computer program stored thereon which, when executed by a processor, realizes steps of any one of the above methods.

With the above technical scheme, the disclosure presents obvious technical effects as follows.

According to the disclosure, when the completion progress of the job in the system is updated, embedding feature vector extraction can be performed on the native feature data by the graph convolution neural network to obtain the state feature vectors of the respective tasks, a task scheduled in a current round can be determined based on the state feature vectors, and an appropriate node can be selected for the task based on the state feature vectors. Because the state feature vectors include resource occupation information and node allocation information, data positions of interdependent tasks can be embodied to guide generation of a scheduling strategy that can reduce overhead in data transmission among the interdependent tasks.

### BRIEF DESCRIPTION OF THE DRAWINGS

In order to explain the embodiments of the present disclosure or the technical scheme in the prior art more clearly, the drawings required in the description of the embodiments or the prior art will be briefly introduced below; obviously, the drawings in the following description are only some embodiments of the present disclosure, and other drawings can be obtained according to these drawings by those of ordinary skill in the art without paying creative labor.

FIG. 1 is a schematic view of a DAG job;

FIG. 2 is a schematic view of life cycles of respective tasks in the DAG job shown in FIG. 1;

FIG. 3 is a flowchart of a DAG job scheduling method according to the present disclosure; and

FIG. 4 is a schematic structural view of a DAG job scheduling system according to the present disclosure.

### DETAILED DESCRIPTION

The present disclosure will be further described in detail with reference to the following examples which present explanation the present disclosure and the present disclosure is not limited to the following examples.

### DESCRIPTION

(1) Virtual machine node and cluster: A cluster is composed of several virtual machine (VM) nodes, hereinafter referred to as nodes for short;

In this specification, a cluster is represented by C≙{c₁, c₂, . . . , c_{M}}, in which ci represents an i-th node. All of the virtual machine nodes can communicate with each other, and they form a fully connected graph. At any time, residual amount

$${r}_{i} {=}^{△}$$

of various resources of any of the nodes can be known, in which rᵢ^{q} represents residual amount of a q-th class of resource of a node cᵢ, and

$${=}^{△} \{ 1 , 2 , … , Q \}$$

is a set of an or resource classes.

In actual use, resources can be classified according to actual needs, such as CPU, memory, network bandwidth, hard disk capacity, etc., and the nodes can be heterogeneous, that is can have completely different initial resources.
(2) Job and task:
A job consists of a series of interdependent tasks, such as segmentation, transcoding, merging, etc. The scheduling method according to the disclosure is suitable for a gene computing job and a video transcoding job.

A user can indicate dependence of respective tasks in a job and amount of requests for various resources by the respective tasks in a yaml file when a job is submitted.

A job can be modeled as a directed acyclic graph (DAG). The DAG can have multiple incoming tasks and multiple outgoing tasks according to actual situations.

For a single job, its tasks are divided into incoming tasks and remaining tasks.

Incoming task, which needs to pull a data set from Object Storage Service (OBS) as input. A pulling process for the data set consumes bandwidth and involves an important part of job completion time. Different data sets or a same data set may be pulled for an incoming task(s) of a same job. If these incoming tasks are scheduled to a same virtual machine node and required data sets are same, pulling from the OBS to the virtual machine node is only needed once. After the incoming tasks is processed, a processing result may be sent to its subtasks.

Remaining task, which only needs to process data from the parent task, regardless of data sets stored in an OBS memory. Similarly, each task needs to send a processing result to a subtask it is directed to. If the task is an outgoing task, a processing result needs to be sent back to the OBS. A sending-back process of the processing results of the data set consumes bandwidth and involves an important part of job completion time.
(3) Scheduling strategy:

Scheduling refers to placing a task of a job on a virtual machine node at a certain moment.

A task can be placed on a certain virtual machine node only if the virtual machine node meets a resource request of the task.

At any moment, unfinished jobs in the system vary dynamically in real time, and resource surplus of respective nodes in the cluster also vary in real time.
(4) Life cycle analysis of job:

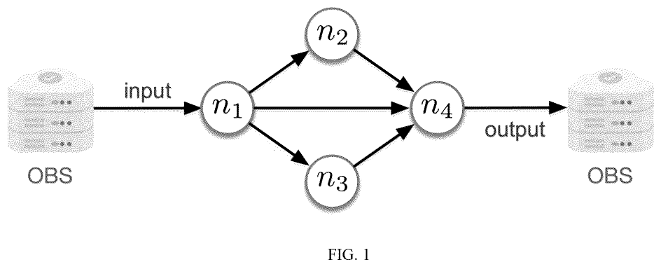

Taking the DAG job shown in FIG. 1 as an example, following explanation are made.

In FIG. 1, n₁ to n₄ represent tasks. After this job is submitted, a first task n₁ is taken as an incoming task, and there is no preceding task to wait, and thus it is immediately placed in a queue to be scheduled for execution. Reasons for waiting include that there are no node that meets a corresponding resource requirement currently, or there are other tasks with higher priorities (tasks of other jobs) in a current scheduling cycle, and thus a status of n at this time is marked as pending. After waiting, a corresponding node p(n₁) is assigned to the task n₁, that is, the task n₁ is scheduled.

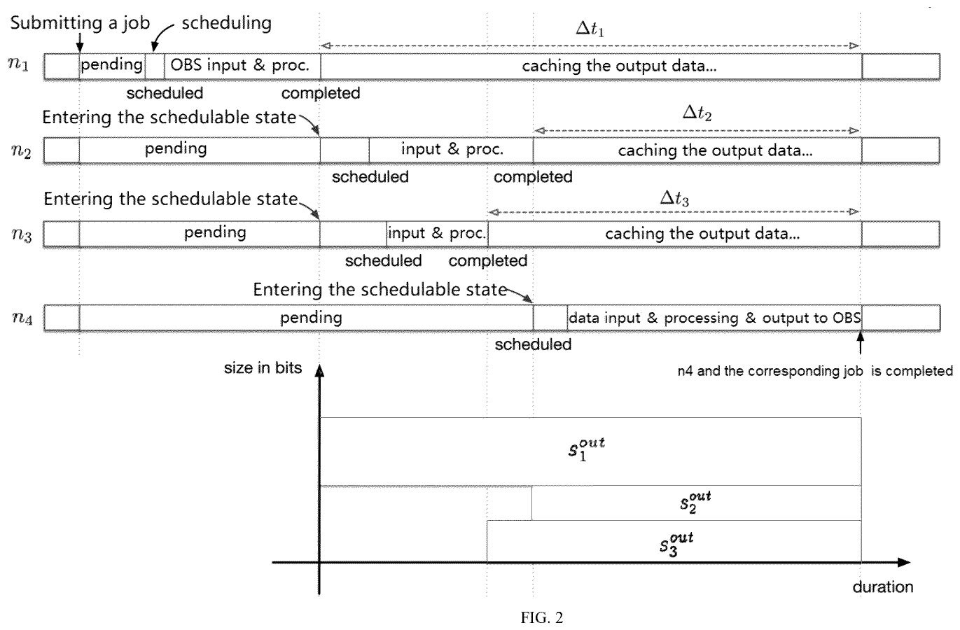

FIG. 2 shows scheduling moments and completion moments of respective tasks of the job shown in FIG. 1, as well as caching sizes and time periods of data of respective tasks on bound nodes. Before a task is executed, it may go through two states: waiting state and scheduling state. A task in the pending state cannot be scheduled. A task in the scheduling state can be scheduled. According to functions registered in Kubernetes, they may perform enqueuing (being taken into a queue), allocating (optimizing), preempting (priority scheduling), reclaiming (queue weight resource recycling), backfilling (maximizing of scheduling) and other actions in turn, and then be bound to an appropriate node.

An execution process of the task is to reading required data into a memory, processing it, and outputting data to a buffer (or a hard disk). These three steps can be carried out at the same time, that is, the reading can be performed while processing (and outputting). After the execution is completed, output data of the task may be cached on a hard disk where the scheduled node is mounted, and resources occupied by the task (pod corresponding thereto) may be released and the pod itself is destroyed. With completion of a parent task, its subtask can be in a scheduling state.

Taking n₁ as an example, its output data amount is s¹², s¹³ and s¹⁴ (with a sum of s₁^{out}), which are inputs to n₂ to n₄ respectively. The subtask often reads all of cached data output by the parent task, and then determines a part of the data they really need according to execution content. Therefore, a cache duration of the data output by the parent task is difference between completion time of a slowest subtask and completion time of the parent task. Refer to FIG. 2, and cache occupation of s¹² and s¹³ may not be released until n₄ is destroyed.

Therefore, cache overhead of intermediate data of the job shown in FIG. 1 can be embodied by a sum (Δt₁·s₁^{out}+Δt₂·s₂^{out}+Δt₃·s₃^{out}) of multiplication of cache amount of respective intermediate data by corresponding cache existence durations, where Δtᵢ represents difference between completion time of a slowest subtask of the task nᵢ and completion time of the task nᵢ.
(5) Optimization objective of the scheduling method according to the disclosure:

Advancement of completion time of a last job.

Completion time of a job refers to completion time of a last completed task of the job. During operation of Kubernetes, there may be many jobs to be submitted at an initial moment and there may be new jobs to be submitted at any time during job execution, and thus this optimization goal refers to advance the completion time of the completed task job as much as possible.

Reducing of caching overhead occupied by intermediate data in a cluster.

It can be seen from the above that the output data of the parent task may need to be temporarily cached locally, which needs to occupy hard disk resources of the virtual machine node. Even if a pair of dependent tasks are scheduled to a same virtual machine node, data may still be cached (depending on a waiting duration of the parent task), but time cost of data transmission is zero at this time. This optimization objective is to minimize occupation of the hard disk resources in the cluster by the intermediate data.

Embodiment 1: a DAG job scheduling method includes following steps S100 to S400 when a progress state of a job is updated.

At S100, native feature data of each of jobs is acquired.

The native feature data includes a job native feature vector and task native feature vectors in one-to-one correspondence to tasks.

The job native feature vector includes node allocation information of the job.

Each of the task native feature vectors includes the node allocation information and further includes resource occupation information of a corresponding task.

In this embodiment:

A job native feature vector corresponding to an i-th job is written as x, and a task native feature vector corresponding to a v-th task in the i-th job is written as xx.

The node allocation information includes a number of different nodes that have been allocated to the job (an integer type variable) and information about whether a first node in a current node queue to be allocated has been allocated to a task of the job (a boolean type variable).

The resource occupation information includes input data amount (a float type variable), output data amount (a float type variable) and (estimated) remaining execution time (a float type variable) of the corresponding task, and caching durations (a float type variable) of respective output data ∀nⱼ∈ξᵢ:sᵢⱼ, in which ξᵢ represents a set of all of subtasks of a task nᵢ.

Note: The job refers to a job to be completed.

At S200, embedding feature vector extraction is performed on the native feature data based on a graph convolution neural network, and state feature vectors are generated based on an extraction result.

Tasks of the jobs are recorded as candidate tasks, and the state feature vectors are in one-to-one correspondence to the candidate tasks.

At S300, the state feature vectors are input into a first prediction network, and scheduling probability of respective candidate tasks is predicted by the first prediction network to obtain scheduling priorities of the respective candidate tasks.

At S400, allocation nodes are selected for the candidate tasks sequentially in an order of the scheduling priorities from large to small based on the state feature vectors and a scheduling strategy is generated based on a selection result.

In this embodiment, when the completion progress of the job in the system is updated, embedding feature vector extraction can be performed on the native feature data by the graph convolution neural network to obtain the state feature vectors of the respective tasks, a task scheduled in a current round can be determined based on the state feature vectors, and an appropriate node can be selected for the task based on the state feature vectors. Because the state feature vectors include resource occupation information and node allocation information, data positions of interdependent tasks can be embodied to guide generation of a scheduling strategy that can reduce overhead in data transmission among the interdependent tasks.

Further, the extraction result in step S200 includes:
task embedding feature vectors in one-to-one correspondence to the candidate tasks;
job embedding feature vectors in one-to-one correspondence to the jobs; and
a global embedding feature vector.

The state feature vectors includes the global feature vector, and further includes task feature vectors corresponding to the candidate tasks and a job feature vector.

The embedding feature vector is essentially compressed perception of original features and structural information of a graph, so that unstructured features are preserved in a numerical way. In this embodiment, the graph convolution neural network is adopted to perform the embedding feature vector extraction.

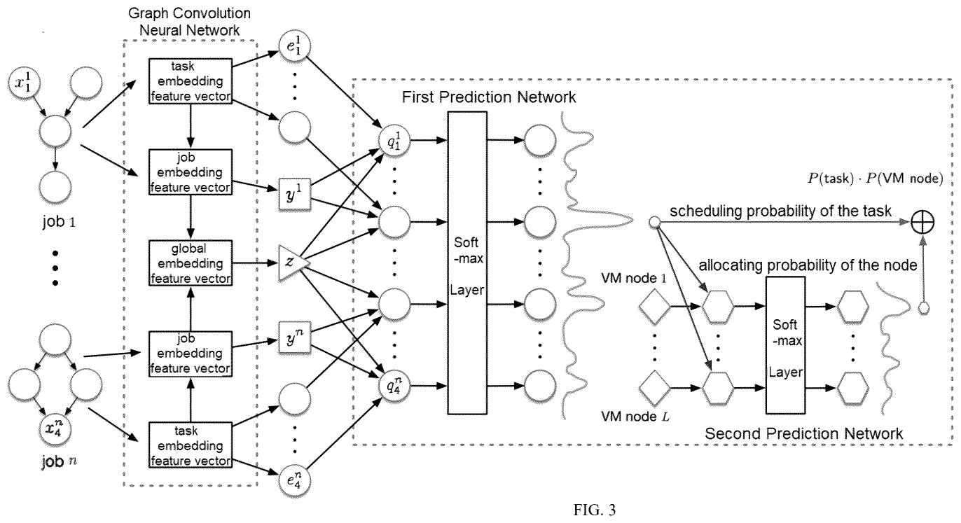

Referring to FIG. 3, the graph convolution neural network in this embodiment includes a first extraction network, a second extraction network and a third extraction network.

The first extraction network is
configured to generate a task embedding feature vector of a candidate task based on a job native feature vector and a task native feature vector of the candidate task and a task embedding feature vector of a child task of the candidate task.

In this embodiment, the task embedding feature vector is extracted by a following formula:

$${e}_{v}^{i} = {g}_{1} [ {\sum }_{u ∈ {ξ}_{v}} {f}_{1} ( {e}_{u}^{i} ) ] + {x}_{v}^{i}$$

in which
eᵥⁱ represents a task embedding feature vector corresponding to a v-th task of an i-th job;
ξᵥ represents a set of all of subtasks of the v-th task nᵥ; eᵤⁱ represents an embedding feature vector corresponding to a u-th task of the i-th job, which is a subtask of the task nᵥ; and
xᵥⁱ represents a task native feature vector of the v-th task of the i-th job.

f₁ and g₁ each represent a nonlinear mapping function, and both adopt a fully connected neural network with three hidden layers, that is, the first extraction network contains a first fully connected neural network for realizing f₁ nonlinear mapping and a second fully connected neural network for realizing g₁ nonlinear mapping, and these two fully connected neural networks are shared in feature extraction of all of tasks of all of jobs.

It can be seen from the above that a task embedding feature vector of a task is a result of combining nonlinear transformation of task embedding feature vectors of all of its subtasks with a task native feature vector of the task.

The second extraction network is configured to generate a job embedding feature vector of a job based on a job native feature vector of the job and task embedding feature vectors corresponding to the job.

In this embodiment, the job embedding feature vector is extracted by a following formula:

$${y}^{i} = {g}_{2} [ {\sum }_{∀ v ∈ {m}_{i}} {f}_{2} ( {e}_{v}^{i} ) ] + {x}^{i}$$

in which
yⁱ represents a job embedding feature vector corresponding to an i-th job;
mᵢ represents the i-th job;
eᵥⁱ represents a task embedding feature vector corresponding to a v-th task of the i-th job; and
xⁱ represents a job native feature vector of the i-th job.
f₂ and g₂ each represent a nonlinear mapping function, and both adopt a fully connected neural network with three hidden layers, that is, the second extraction network contains a third fully connected neural network for realizing f₂ nonlinear mapping and a fourth fully connected neural network for realizing g₂ nonlinear mapping.

It can be seen from the above that a job embedding feature vector of a job is a result of combining nonlinear transformation of task embedding feature vectors of all of its tasks with a job native feature vector of the job.

The third extraction network is configured to generate the global embedding feature vector based on respective job embedding feature vectors.

In this embodiment, a global embedding feature vector z is extracted by a following formula:

$$z = {g}_{3} [ {\sum }_{∀ {m}_{i}} {f}_{3} ( {y}^{i} ) ]$$

in which
mᵢ represents an i-th job;
yⁱ represents a job embedding feature vector corresponding to the i-th job;
f₃ and g₃ each represent a nonlinear mapping function, and both adopt a fully connected neural network with three hidden layers, that is, the third extraction network contains a fifth fully connected neural network for realizing f₃ nonlinear mapping and a sixth fully connected neural network for realizing g₃ nonlinear mapping.

In this embodiment, the graph convolution neural network includes six fully connected neural networks each including three hidden layers, and a number of neurons in the three hidden layers is set to be 16, 32 and 16 sequentially.

An extraction convolution neural network output is ([eᵥⁱ]_{∀v,∀i},[yⁱ]_{∀i},z):

For any of the candidate tasks, a state feature vector is constructed based on its associated task embedding feature vector eᵥⁱ, job embedding feature vector yⁱ and global embedding feature vector z.

Referring to FIG. 3, in this embodiment, the inputting the state feature vectors into a first prediction network and predicting scheduling probability of respective candidate tasks by the first prediction network is specifically implemented as follows.

Firstly, the state feature vector of the candidate task (a v-th task of the i-th job) is input into a nonlinear mapping to get an output qᵥⁱ.

$${q}_{v}^{i} = q ( {e}_{v}^{i} , {y}^{i} , z )$$

q represents a fully connected neural network with three hidden layers.

Then all of [qᵥⁱ]_{∀i,∀v} are input into a SoftMax layer, which returns probability that each of all of the tasks is selected.

That is, the first prediction network in this embodiment includes a first feature transformation network and a first output network.

An input of the first feature network is all of the state feature vectors, and the first feature network is the fully connected neural network q.

An input of the first output network is an output of the first feature network, and the output is probability that each of the respective candidate tasks is selected, and the first output network is a SoftMax layer.

It is noted that if a task cannot be scheduled, a corresponding mask variable may directly set selecting probability of the task to 0.

In this embodiment, the selecting allocation nodes for the candidate tasks specifically includes steps 410 to S440.

At S410, a candidate task currently to be allocated with a node is taken as a target task.

At S420, a nodes meeting execution of the target task is screened out to obtain a candidate node.

That is, a node that meets resource requirements of the target task is screened as a candidate node.

At S430, node feature vectors of respective candidate nodes are acquired, and each of the node feature vectors includes resource utilization data of a corresponding node.

The resource utilization data includes a size of link bandwidth between the virtual node and OBS, a CPU frequency of the virtual machine node and other characteristics.

At S440, allocating priorities of the respective candidate nodes are calculated based on the node feature vectors and a state feature vector of the target task and a candidate node with a highest allocating priority is taken as a target node of the target task.

That is, allocating probabilities of the respective candidate nodes are predicted by a second prediction network based on the node feature vectors and the state feature vector of the target task so as to obtain the allocating priorities of the respective candidate nodes.

Referring to FIG. 3, this can be specifically implemented as follows.

Nonlinear mapping is performed on the node feature vectors and the state feature vector of the target task.

$${w}_{l} = w ( {q}_{ν}^{i} , {h}_{l} )$$

in which
wₗ represents a nonlinear mapping result of a l-th candidate node corresponding to the target task;
hₗ represents a node feature vector of the l-th candidate node corresponding to the target task;
w represents a fully connected neural network with three hidden layers.

Likewise, all of [wₗ]_{∀l} are input into a SoftMax layer, which returns probability that each of all of candidate virtual machine nodes is selected.

That is, the second prediction network in this embodiment includes a second feature transformation network and a second output network.

An input of the second feature network is a sum of the node feature vectors of all of the candidate nodes corresponding to the target task, and the first feature network is the fully connected neural network q.

An input of the first output network is an output of the first feature network, and the output is probability that each of the respective candidate tasks is selected, and the first output network is a SoftMax layer.

In this embodiment, the scheduling strategy includes at least one scheduling action, and the at least one scheduling action is used to indicate a task and a node for performing of scheduling, that is, a pair of target task and target node obtained through above steps form a scheduling action.

After the scheduling strategy is generated, rewards corresponding to respective scheduling actions are further calculated based on a preset optimization goal, and an accumulated reward is obtained by statistics.

The preset optimization goal is to advance completion time of a last job and reduce caching overhead occupied by intermediate data in a cluster.

The accumulated reward is used to update the graph convolution neural network, the first prediction network and the second prediction network, that is, to update parameters of the eight fully connected neural networks.

A formula for calculating a reward rₖ₋₁ of a k−1-th scheduling action is:

$${r}_{k - 1} = - ( {t}_{k} - {t}_{k - 1} ) ( \vert {J}_{k} \vert + \vert ξ ( {J}_{k} ) \vert ) ;$$

in which
tₖ represents global time when a k-th scheduling action is triggered;
tₖ₋₁ represents global time when a k−1-th scheduling action is triggered;
Jₖ is a set of unfinished tasks in a time period [tₖ₋₁, tₖ);
ξ(Jₖ) is a set of parent tasks of all of tasks in Jₖ;
   |Jₖ| is a number of elements in Jₖ; and
   |ξ(Jₖ)| is a number of elements in ξ(Jₖ).

A first term, a penalty term, in the above formula is used to penalize completion time, and the second penalty, also a penalty term, is used to penalize a situation where a caching space occupied by output data of a completed parent task cannot be released because its subtask is not completed. Considering that input and output amount of intermediate data can't be detected and further output data of the task is not optimized (it may not vary with performance of a scheduling algorithm), penalization is only performed based on in a “quantity” dimension.

In this embodiment, an Actor-Critic algorithm is used to update the parameters of the above eight fully connected neural networks.

If θ represents all of the parameters of a proxy (including weights and offsets of all of the eight fully connected neural networks), sₖ is used to represent a state input (that is, an input of the first prediction network) from environment that triggers a k-th scheduling action, and aₖ is used to represent a k-th scheduling action which is legal in a current state, then a parameter updating formula corresponding to all of quadruplets (sₖ, aₖ, rₖ, sₖ₊₁) is:

$$θ ← θ + γ {\sum }_{k = 1}^{T} {∇}_{θ} log {π}_{θ} ( {s}_{k} , {a}_{k} ) ( {\sum }_{{k}^{′} = k}^{T} {r}_{{k}^{′}} - {b}_{k} ) ,$$

in which π_{θ}(sₖ, aₖ) represents probability that a scheduling action aₖ is selected in a state sₖ, that is, P(task)·P (VM node) in FIG. 3; γ is a rate of parameter updating; Σ_{k′=k}^{T}r_{k′} represents an accumulated reward from a current step to end of the algorithm; bₖ is a baseline function value in a k-th round, which exists to reduce influence of excessive variance of quadruplets (sₖ, aₖ, rₖ, sₖ₊₁) on training efficiency.

Note: training of the graph convolution neural network, the first prediction network and the second prediction network is to update the parameters based on the Actor-Critic algorithm in a simulation environment, which is same as the above and thus is not repeated in this specification.

In this embodiment, the updating of the progress status of the job involves that
when any of the jobs is completed, occupied resources allocated to all of its nodes are released;
when any of the tasks is completed, one or more of its subtasks can enter a schedulable state; or
a new job is submitted.

In the disclosure, optimal scheduling from a task container to virtual machine nodes can be realized by integrating task dependency, data positions and the like, overhead of data transmission between adjacent dependent tasks is reduced while the job completion time is minimized, and priorities of the schedulable tasks and the candidate virtual machine nodes are optimized by establishing an affinity relationship between the task and data, and thus an optimal start of the job can be realized.

Embodiment 2: A DAG job scheduling system includes a proxy, and the proxy includes:
a monitoring module configured to acquire and transmit native feature data of each of jobs when a progress state of the job is updated;
the native feature data including a job native feature vector and task native feature vectors in one-to-one correspondence to tasks;
the job native feature vector including node allocation information of the job; and
each of the task native feature vectors including the node allocation information and further including resource occupation information of a corresponding task; and
a proxy pattern configured to generate a corresponding scheduling strategy based on the native feature data.

The proxy pattern includes:
a feature extraction unit configured to perform embedding feature vector extraction on the native feature data based on a graph convolution neural network, and generate state feature vectors based on an extraction result; and record tasks of the jobs as candidate tasks, the state feature vectors being in one-to-one correspondence to the candidate tasks;
a first strategy unit configured to the state feature vectors into a first prediction network, and predicting scheduling probability of respective candidate tasks by the first prediction network to obtain scheduling priorities of the respective candidate tasks; and
a second strategy unit configured to select allocation nodes for the candidate tasks sequentially in an order of the scheduling priorities from large to small and generate a scheduling strategy based on a selection result.

Further, the DAG job scheduling system further includes a Kubernetes platform;

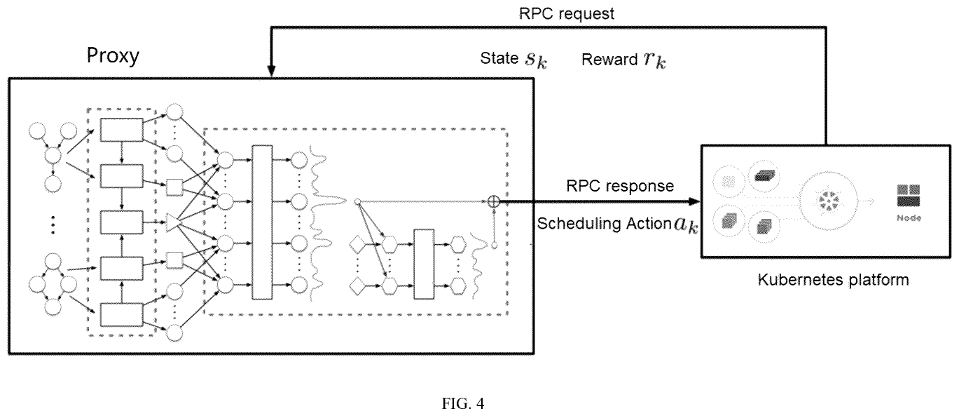

Referring to FIG. 4, the Kubernetes platform is configured to generate a corresponding RPC request when the progress state of the job is updated, and the RPC request includes the native feature data of each of the jobs.

The monitoring module is configured to receive the RPC request and obtain the native feature data.

The second strategy unit is further configured to generate a corresponding RPC response based on the scheduling strategy and feedback the RPC response to the Kubernetes platform.

Embodiment 3: a computer-readable storage medium having computer program stored thereon which, when executed by a processor, realizes steps of the method described in Embodiment 1.

As for device embodiments, they are basically similar to method embodiments and description thereof is relatively simple, and reference can be made to the description of the method embodiment for relevant aspects.

All the embodiments in this specification are described in a progressive way, and each embodiment focuses on differences from other embodiments. The same and similar parts among the embodiments can be referred to each other.

It should be understood by those skilled in the art that embodiments of the present disclosure may be provided as a method, a device, or a computer program product. Therefore, the present disclosure may be implemented in an entire hardware embodiment, an entire software embodiment, or an embodiment combining the software and the hardware. Furthermore, the present disclosure may be implemented in the form of a computer program product embodied on one or more computer usable storage media (including but not limited to disk memory, CD-ROM, optical memory, etc.) having computer usable program code contained therein.

The present disclosure is described with reference to a flowchart and/or block diagram of a method, a terminal device (system), and a computer program product according to the present disclosure. It should be understood that each flow and/or block in the flowchart and/or block diagram, or a combination of flows and/or blocks in the flowchart and/or block diagram can be implemented with computer program instructions. These computer program instructions can be provided to a processor of a general purpose computer, a special purpose computer, an embedded processor or other programmable data processing terminal device to produce a machine, so that the instructions executed by the processor of the computer or other programmable data processing terminal device produce means for implementing the functions specified in one or more flows in the flowchart and/or in one or more blocks in block diagram.

These computer program instructions can also be stored in a computer-readable memory that can guide a computer or other programmable data processing terminal device to work in a specific way, so that the instructions stored in the computer-readable memory produce an article of manufacture including instruction means that implements the functions specified in one or more flows in the flowchart and/or in one or more blocks in the block diagram.

These computer program instructions can also be loaded on a computer or other programmable data processing terminal device, so that a series of operation steps are executed on the computer or other programmable terminal device to produce computer-implemented processing, so that the instructions executed on the computer or other programmable terminal device provide steps for implementing functions specified in one or more flows in the flowchart and/or in one or more blocks in block diagrams.

It should be noted that:

Reference to “one embodiment” or “an embodiment” in the specification means that a specific feature, structure or characteristic described in connection with embodiments is included in at least one embodiment of the present disclosure. Therefore, the phrases “one embodiment” or “an embodiment” appearing in various places throughout the specification do not necessarily refer to the same embodiment.

Although the preferred embodiments of the present disclosure have been described, additional changes and modifications can be made to these embodiments by those skilled in the art once basic inventive concepts are known. Therefore, the appended claims are intended to be interpreted as including the preferred embodiments and all changes and modifications falling within the scope of the present disclosure.

In addition, it should be noted that the specific embodiments described in this specification may have different shapes, names or the like of parts and components. Equivalent or simple changes made in accordance with the configurations, features and principles described in the inventive concept are included in the scope of protection of the inventive disclosure. Various modifications, supplements or similar replacements can be made to the described specific embodiments by those skilled in the art to which the present disclosure pertains, which fall within the protection scope of the present disclosure without departing from the structure of the present disclosure or beyond the scope defined by the claims.

1. A DAG job scheduling method, comprising: when a progress state of a job at a proxy is updated,
acquiring native feature data of each of jobs from an Object Storage Service;
the native feature data comprising a job native feature vector and task native feature vectors in one-to-one correspondence to tasks;
the job native feature vector comprising node allocation information of the job; and
each of the task native feature vectors comprising the node allocation information and further comprising resource occupation information of a corresponding task;
performing embedding feature vector extraction on the native feature data based on a graph convolution neural network, and generating state feature vectors based on an extraction result;
recording tasks of the jobs as candidate tasks by the graph convolution neural network, the state feature vectors being in one-to-one correspondence to the candidate tasks;
inputting the state feature vectors into a first prediction network, and predicting scheduling probability of respective candidate tasks by the first prediction network to obtain scheduling priorities of the respective candidate tasks; and
selecting allocation nodes by the proxy for the candidate tasks sequentially in an order of the scheduling priorities from large to small based on the state feature vectors and generating a scheduling strategy based on a selection result.

2. The DAG job scheduling method according to claim 1, wherein
the extraction result comprises:
task embedding feature vectors in one-to-one correspondence to the candidate tasks;
job embedding feature vectors in one-to-one correspondence to the jobs; and
a global embedding feature vector; and
the state feature vectors comprises the global feature vector, and further comprises task feature vectors corresponding to the candidate tasks and a job feature vector.

3. The DAG job scheduling method according to claim 1, wherein
the graph convolution neural network comprises:
a first extraction network configured to generate a task embedding feature vector of a candidate task based on a job native feature vector and a task native feature vector of the candidate task and a task embedding feature vector of a child task of the candidate task;
a second extraction network configured to generate a job embedding feature vector of a job based on a job native feature vector of the job and task embedding feature vectors corresponding to the job;
a third extraction network configured to generate the global embedding feature vector based on respective job embedding feature vectors.

4. The DAG job scheduling method according to claim 1, wherein the selecting allocation nodes for the candidate tasks comprises:
taking a candidate task currently to be allocated with a node as a target task;
screening out a nodes meeting execution of the target task to obtain a candidate node;
acquiring node feature vectors of respective candidate nodes, each of the node feature vectors comprising resource utilization data of a corresponding node; and
calculating allocating priorities of the respective candidate nodes based on the node feature vectors and a state feature vector of the target task and taking a candidate node with a highest allocating priority as a target node of the target task.

5. The DAG job scheduling method according to claim 4, wherein
allocating probabilities of the respective candidate nodes are predicted by a second prediction network based on the node feature vectors and the state feature vector of the target task so as to obtain the allocating priorities of the respective candidate nodes.

6. The DAG job scheduling method according to claim 1, wherein the scheduling strategy comprises at least one scheduling action, and the at least one scheduling action is used to indicate a task and a nodes for performing of scheduling;
after the scheduling strategy is generated, rewards corresponding to respective scheduling actions are calculated based on a preset optimization goal, and an accumulated reward is obtained by statistics;
the preset optimization goal is to advance completion time of a last job and reduce caching overhead occupied by intermediate data in a cluster; and
the accumulated reward is used to update the graph convolution neural network and the first prediction network.

7. The DAG job scheduling method according to claim 6, wherein a formula for calculating a reward rₖ₋₁ of a k−1-th scheduling action is:
$${r}_{k - 1} = - ( {t}_{k} - {t}_{k - 1} ) ( \vert {J}_{k} \vert + \vert ξ ( {J}_{k} ) \vert ) ;$$
wherein:
tₖ represents global time when a k-th scheduling action is triggered;
tₖ₋₁ represents global time when a k−1-th scheduling action is triggered;
Jₖ is a set of unfinished tasks in a time period [tₖ₋₁, tₖ);
ξ(Jₖ) is a set of parent tasks of all of tasks in Jₖ;

|Jₖ| is a number of elements in Jₖ; and

|ξ(Jₖ)| is a number of elements in ξ(Jk).

8. A DAG job scheduling system comprising a proxy, and the proxy comprising:
a monitoring module configured to acquire and transmit native feature data of each of jobs when a progress state of the job is updated;
the native feature data comprising a job native feature vector and task native feature vectors in one-to-one correspondence to tasks.
the job native feature vector comprising node allocation information of the job; and
each of the task native feature vectors comprising the node allocation information and further comprising resource occupation information of a corresponding task; and
a proxy pattern configured to generate a corresponding scheduling strategy based on the native feature data; wherein
the proxy pattern comprises:
a feature extraction unit configured to perform embedding feature vector extraction on the native feature data based on a graph convolution neural network, and generate state feature vectors based on an extraction result; and record tasks of the jobs as candidate tasks, the state feature vectors being in one-to-one correspondence to the candidate tasks;
a first strategy unit configured to the state feature vectors into a first prediction network, and predicting scheduling probability of respective candidate tasks by the first prediction network to obtain scheduling priorities of the respective candidate tasks; and
a second strategy unit configured to select allocation nodes for the candidate tasks sequentially in an order of the scheduling priorities from large to small and generate a scheduling strategy based on a selection result.

9. The DAG job scheduling method according to claim 8, further comprising a Kubernetes platform; wherein
the Kubernetes platform is configured to generate a corresponding RPC request when the progress state of the job is updated, and the RPC request comprises the native feature data of each of the jobs;
the monitoring module is configured to receive the RPC request and obtain the native feature data; and
the second strategy unit is further configured to generate a corresponding RPC response based on the scheduling strategy and feedback the RPC response to the Kubernetes platform.

10. A computer-readable storage medium, having a computer program stored thereon which, when executed by a processor, realizes steps of the method according to claim 1.

11. A computer-readable storage medium, having a computer program stored thereon which, when executed by a processor, realizes steps of the method according to claim 2.

12. A computer-readable storage medium, having a computer program stored thereon which, when executed by a processor, realizes steps of the method according to claim 3.

13. A computer-readable storage medium, having a computer program stored thereon which, when executed by a processor, realizes steps of the method according to claim 4.

14. A computer-readable storage medium, having a computer program stored thereon which, when executed by a processor, realizes steps of the method according to claim 5.

15. A computer-readable storage medium, having a computer program stored thereon which, when executed by a processor, realizes steps of the method according to claim 6.

16. A computer-readable storage medium, having a computer program stored thereon which, when executed by a processor, realizes steps of the method according to claim 7.
